(19) United States
(12) Patent Application Publication
(10) Pub. No.: US 2025/0105760 A1
(43) Pub. Date: Mar. 27, 2025

(54) ACTIVE DC BUS DISCHARGE

(71) Applicant: Allegro MicroSystems, LLC, Manchester, NH (US)

(72) Inventors: Maurizio Salato, Bedford, MA (US); Vijay Mangtani, Nashua, NH (US); Tue Vu, Dublin (IE)

(73) Assignee: Allegro MicroSystems, LLC, Manchester, NH (US)

(21) Appl. No.: 18/471,443

(22) Filed: Sep. 21, 2023

(51) Int. Cl. H02M 7/5387; B60L 15/08; H02M 1/088; H02P 27/08

(52) U.S. Cl. CPC H02M 7/53871; B60L 15/08; H02M 1/088; H02P 27/08

(57) ABSTRACT

Systems, circuits, and methods provide controlled active DC bus discharge, such as for electric vehicles (EVs) or hybrid vehicles. Controlled active DC bus discharge can be provided using gate drivers to control operation of traction inverter switches, such as power transistors, to accomplish a charge bleeding function. Power transistors can be configured so that the gate is connected to the drain, thereby forcing the gate threshold voltage across drain and source. The gate of a power transistor can be actively driven between a threshold voltage and Miller plateau threshold voltage. As a result, several volts can be generated across the power transistor while current decays, therefore safely discharging the system DC bus.

### BACKGROUND

Electric vehicles (EVs) typically include one or more alternating current (AC) motors and a traction inverter, which is a power electronic device/system that converts a direct current (DC) supply of power from the vehicle's batteries to an AC output for use by the vehicle's one or more electric motors. The AC output is then used to power the electric motor(s) providing drive for the vehicle. Traction inverters are sometime also referred to as variable frequency drives, motor drives, traction drives, and variable speed drives. Traction inverters typically include semiconductor switches such as semiconductor devices like insulated-gate bipolar transistors (IGBTs) or silicon carbide (SiC) transistors. In electric and hybrid vehicles, the electric motor can also act as a generator during regenerative braking, converting the vehicle's kinetic energy into AC power. This is then converted back to DC power by the traction inverter, allowing the battery to be charged.

In a typical AC motor, the current in each winding having a different phase (e.g., one of three) alternates the direction of flow between positive and negative at the right time according to the motor shaft rotation and desired torque. The faster the motor speed, the more frequent the alternation of current. This variable rate of changing current direction or frequency is precisely controlled by the traction inverter. The traction inverter operates to ensure the correct current is flowing in the motor phases at any instant by continuously monitoring the motor shaft angle and calculating the necessary current to produce the desired torque.

The semiconductor switches (e.g., IGBTs or SiC transistors) used in traction inverters act as high-speed switches that turn on and off, typically thousands of times per second. When these switches are off, current does not flow (at least not to an appreciable degree). Conversely when the switches are on, current flows, creating a pulse of energy. By varying the width and frequency of these pulses (a technique known as pulse-width modulation, or “PWM”), the traction inverter can create an AC waveform for the motor(s).

Traction inverters typically include capacitor banks of one or more capacitors, which can store considerable, e.g., dangerous, amounts of charge. For safety reasons, various regulatory requirements applicable to EVs can require discharge of an EV's inverter capacitor bank under certain circumstances, e.g., shortly after the battery is disconnected, when the vehicle is turned off, or in the event of an accident involving the EV. Prior art solutions involve using a dedicated power transistor and high-voltage (HV) resistor, resulting in extra cost, and requiring extra space (footprint) for the traction inverter.

FIG. 1 diagram of is a schematic diagram of a prior art traction inverter circuit 100 used for EV applications. Circuit 100 includes battery 101 and a DC bus with circuit portions 102, 103 connected to positive and negative terminals of battery 101, respectively. Circuit 100 includes switch 104 and DC bus capacitor bank 105, which can include one or more capacitors of suitable size(s). A bleed resistor 107, solid state switch 108, and discharge controller 109 are present for discharging the DC bus capacitor bank 105. Multiple solid state switches are included in circuit 100 for converting DC power from battery 101 to AC power for motor 120 and for the reverse process of converting AC power from motor 120 to DC power for storage in/charging of battery 101, e.g., during regenerative braking where the motor 120 is used for slowing (braking) the EV.

In order to safely and effectively discharge a capacitor bank, it is necessary to (i) control the peak discharge current to a maximum, and (ii) safely dissipate the energy extracted from the capacitors. A common approach for discharging a capacitor bank includes using a “bleeder” resistor 107 with a series switch 108, as shown in FIG. 1.

While in off-line (i.e., battery-disconnected) applications, the bleeder resistor is typically used to dissipate power from motor braking events. In battery applications, however, regenerative power is stored back into the battery, making the bleed resistor an inefficient overhead for only sporadic use.

### SUMMARY

An aspect of the present disclosure is directed to and includes include systems, circuits, and methods providing controlled active DC bus discharge.

One general aspect of the present disclosure includes a system for discharging a capacitor bank of a DC bus in a power inverter circuit for an electric motor. The system can include circuitry configured to receive charge from the capacitor bank connected to the DC bus, where the capacitor bank includes one or more capacitors; a plurality of power transistors connected to the DC bus and configured to provide power to the electric motor, where each power transistor has drain, gate, and source terminals; and a plurality of gate drivers connected to the plurality of power transistors, respectively, where the plurality of gate drivers is configured to apply an applied voltage across the plurality of power transistors during a controlled time, respectively, and to cause the plurality of power transistors to conduct current during the controlled time, where charge is controllably dissipated from the capacitor bank during the controlled time. Other embodiments of this aspect include corresponding computer systems, apparatus, and computer programs recorded on one or more computer storage devices, each configured to perform the actions, e.g., of controlling or facilitating control of the described systems.

Implementations may include one or more of the following features. The plurality of gate drivers can be configured to connect the gate terminal to the drain terminal of the plurality of power transistors, respectively, and to apply the applied voltage across the drain and source terminals, respectively. The applied voltage may include a gate threshold voltage of the plurality of power transistors. The applied voltage can be between a gate threshold voltage and a voltage corresponding to a Miller plateau of a gate-charge curve of the plurality of power transistors. The plurality of gate drivers can be configured to a monitor slope change of the gate-charge curve to detect a transition to the Miller plateau. The plurality of gate drivers can be further configured to respond to the transition to the Miller plateau by terminating a charge event of the plurality or power transistors and initiating a discharge event. The plurality of gate drivers can be configured to cause the plurality of power transistors to operate in a linear region of a gain curve of the plurality of power transistors during the controlled time. The plurality of gate drivers may include a plurality of programmable gate drivers. The plurality of programmable gate drivers can be configured to apply the applied voltage according to a duty cycle. The plurality of power transistors may include enhancement mode transistors. The plurality of power transistors may include depletion mode transistors. The plurality of power transistors may include field-effect transistors (FETs). The plurality of power transistors may include metal-oxide-semiconductor field-effect transistors (MOSFETs). The plurality of power transistors may include metal-semiconductor field-effect transistors (MESFETs). The plurality of power transistors may include junction FETs (JFETs). The plurality of power transistors may include silicon carbide (SiC) FETs. The plurality of power transistors may include gallium nitride (GaN) FETs. The system may include a battery configured to provide power to the electric motor. The battery can be configured to store power received from the electric motor. The electric motor may include a permanent magnet synchronous motor (PMSM). The plurality of gate drivers can be configured to adjust the applied voltage based on a temperature associated with the plurality of power transistors. Implementations of the described techniques may include hardware, a method or process, or computer software on a computer-accessible medium.

Another general aspect of the present disclosure includes a method of discharging a capacitor bank coupled to a DC bus in a power inverter circuit for an electric motor. The method can include receiving charge from the capacitor bank connected to the DC bus, where the capacitor bank includes one or more capacitors; using a plurality of gate drivers connected to the plurality of power transistors, respectively, applying an applied voltage across the plurality of power transistors during a controlled time, respectively; causing the plurality of power transistors to conduct current during the controlled time; and discharging the capacitor bank within a desired time. Other embodiments of this aspect include corresponding computer systems, apparatus, and computer programs recorded on one or more computer storage devices, each configured to perform or facilitate performance of the actions of the methods.

Implementations may include one or more of the following features. The plurality of gate drivers can be configured to connect the gate terminal to the drain terminal of the plurality of power transistors, respectively, and to apply the applied voltage across the drain and source terminals, respectively. The applied voltage may include a gate threshold voltage of the plurality of power transistors. The applied voltage can be between a gate threshold voltage and a voltage corresponding to a Miller plateau of a gate-charge curve of the plurality of power transistors. The method may include monitoring a slope change of the gate-charge curve to detect a transition to the Miller plateau. The method may include responding to the transition to the Miller plateau by terminating a charge event of the plurality or power transistors and initiating a discharge event. The plurality of gate drivers can be configured to cause the plurality of power transistors to operate in a linear region of a gain curve of the plurality of power transistors during the controlled time. The plurality of gate drivers may include a plurality of programmable gate drivers. The plurality of programmable gate drivers can be configured to apply the applied voltage according to a duty cycle. The plurality of gate drivers can be configured to apply the applied voltage according to a duty cycle. The plurality of power transistors may include enhancement mode transistors. The plurality of power transistors may include depletion mode transistors. The plurality of power transistors may include FETs. The plurality of power transistors may include MOSFETs. The plurality of power transistors may include MESFETs. The plurality of power transistors may include JFETs. The plurality of power transistors may include silicon carbide (SIC) FETs. The plurality of power transistors may include gallium nitride (GaN) FETs. The electric motor may include a permanent magnet synchronous motor (PMSM). The method may include adjusting the applied voltage based on a temperature associated with the plurality of power transistors. Implementations of the described techniques may include hardware, a method or process, or computer software on a computer-accessible medium.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed examples and embodiments of the present disclose may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, examples and embodiments are illustrated by way of example and not limitation in the figures, in which:

FIG. 1 is schematic diagram of a prior art DC bus discharge circuit;

FIG. 2 is a schematic diagram of an example gate driver circuit, in accordance with an embodiment of the present disclosure;

FIG. 3 is a schematic diagram of an example DC bus discharge circuit, in accordance with an embodiment of the present disclosure;

FIG. 4 includes views (a)-(d) with respective diagrams showing switching characteristics of example power transistors during controlled DC bus discharge, in accordance with embodiments of the present disclosure; view (a) shows a diagram of switching characteristics of the power transistor during controlled DC bus discharge; view (b) shows a diagram including a highlighted portion of a particular area of interest of the diagram of view (a); view (c) shows a diagram depicting application of pre-programmed power transistor gate pulses at a limited voltage level just above gate threshold voltage; and, view (d) depicts a diagram showing operation and monitoring of a power transistor for active DC bus discharging, in accordance with embodiments of the present disclosure; and

FIG. 5 is diagram for an example method of controlled DC bus discharge, in accordance with an embodiment of the present disclosure; and

FIG. 6 is a is a schematic diagram of an example computer system that can perform all or at least a portion of processing, in accordance with the present disclosure.

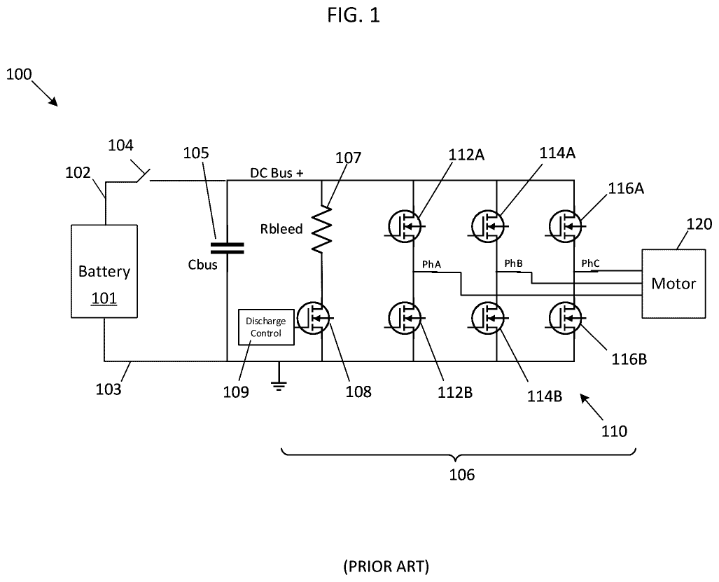

### DETAILED DESCRIPTION

The features and advantages described herein are not all-inclusive; additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects of the present disclosure are directed to and include systems, circuits, and methods providing controlled active DC bus discharge. Examples of the present disclosure can use traction inverter switches to accomplish a charge bleeding function to discharge the DC bus capacitor bank, e.g., when the EV motor is not powered, in accident scenarios, etc.

In some embodiments, power transistors can be configured so that the gate is connected to the drain, thereby forcing the gate threshold voltage across drain and source. In further embodiments, the gate of a power transistor can be actively driven between a gate threshold voltage (Vgs_th) and Miller plateau (a.k.a., Miller region) threshold voltage. As a result of either way/approach, several volts can be generated across the power transistor while current decays, therefore safely discharging the system DC bus.

Some examples and embodiments can include an enhancement-mode (enhancement mode) power transistor configured to work for some time in its linear region. Some examples and embodiments can include a depletion-mode (depletion mode) power transistor configured to work for some time in its linear region.

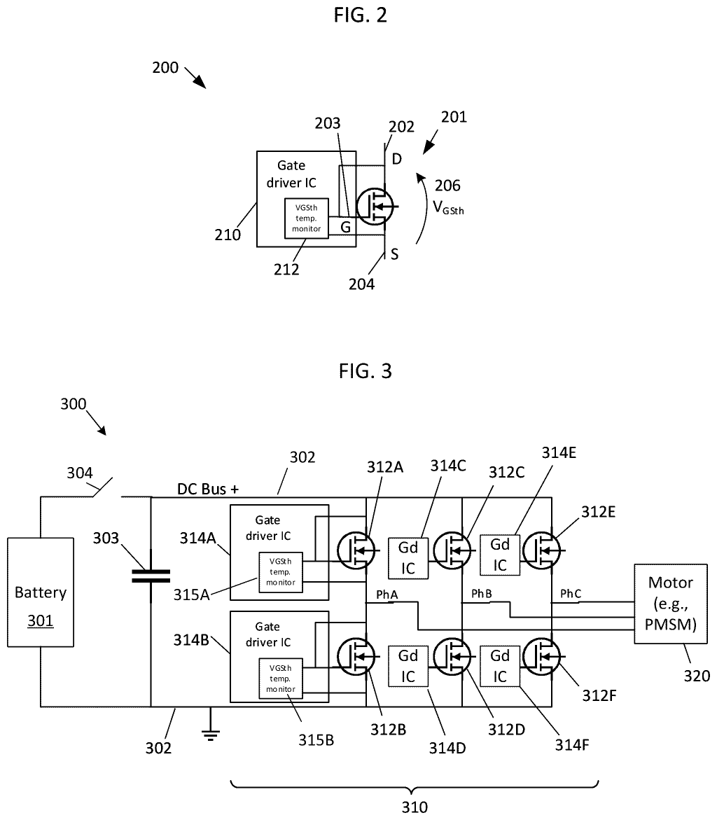

FIG. 2 is a schematic of an example gate driver circuit 200, in accordance with an embodiment of the present disclosure. Gate driver circuit 200 includes a semiconductor power switch (e.g., transistor) 201 with drain, gate, and source terminals 202, 203, and 204, respectively. Gate driver integrated circuit (IC) 210 is connected to the drain, gate, and source terminals 202, 203, and 204. Gate driver IC 210 can include a temperature monitor 212, as shown. In some embodiments, semiconductor power switch 201 can include a power transistor including but not limited to an enhancement mode transistor, a depletion mode transistor, a MOSFET, a MESFET, a JFET, an IGBT, a high electron mobility transistor (HEMT), a SiC transistor, a GaN transistor, or the like.

Gate driver 210 can be connected to and can access the three terminals of power switch (transistor) 201. Gate driver IC 210 (a.k.a., gate driver 210), with its connections to the three terminals of power switch (transistor) 201, is able to configure transistor 201 as in FIG. 2 for a desired finite amount of time or times. Gate driver 210 can maintain the transistor 201 operation in its linear region of its gain curve, for example, by forcing its gate threshold voltage across drain 202 and source 204 when its gate terminal 203 is connected to its drain 202, as shown in FIG. 2. In some embodiments, the drain terminal 202 can be used (e.g., by gate driver 210 or another device/circuit) to detect transistor desaturation and/or clamp overvoltage events.

Gate threshold voltage (Vgs_th) for power devices typically ranges between 2V and 5V, with little dependence on current levels. The gate threshold voltage (Vgs_th) is also die-temperature dependent. This dependency can be used by the driver IC 210 to estimate the temperature rise during a discharge event.

FIG. 3 is a schematic of an example DC bus discharge circuit 300, in accordance with an embodiment of the present disclosure. Circuit 300 includes a DC bus 302 and a capacitor bank 303 having one or more capacitors of suitable size. A switch 304 may also be present. Circuit 300 further includes traction inverter portion 310 include a plurality of semiconductor power switches (e.g., IGBTs or SiC transistors) 312A-F and a plurality of corresponding gate drivers 314A-F, each connected to and accessing the terminals of the respective power switch (e.g., an enhancement mode transistor). Circuit 300 also includes electric motor 320, e.g., a permanent magnet synchronous motor (PMSM). The traction inverter portion 310, with plurality of semiconductor power switches (e.g., six or more IGBTs, GaN transistors, or SiC transistors, two each for each bridge used for a three-phase motor) 312A-F and plurality of corresponding gate drivers 314A-F, is configured to supply motor 320 with AC power, e.g., three-phase AC power as indicated by phases A-C.

As gate threshold voltage (Vgs_th) is typically die-temperature dependent, some embodiments can provide for adjusting operation or compensating for temperature-induced changes in the gate threshold voltage (Vgs_th). As indicated by gate drivers 314A-B, in some embodiments, one or more gate drivers can be configured to or include functionality 315A-B (e.g., processor and/or temperature sensor) to detect and/or estimate temperature rise during a discharge event.

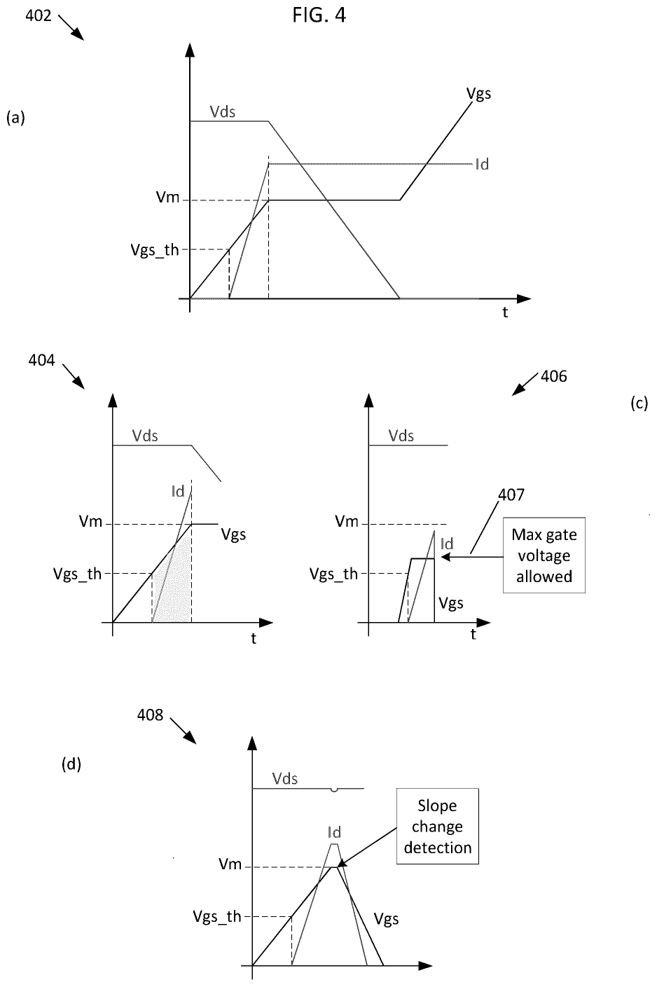

Some examples and embodiments of the present disclosure can include a programmable gate driver circuit (stage) that is able to control charge and discharge of the transistor gate above Vgs_th and below Miller plateau level (Vm). This range on the gate characteristic is usually associated with current transitions, and precedes the Miller plateau, which is associated with the voltage transition, as shown in FIG. 4

FIG. 4 includes views (a)-(d) with diagrams 402-408 showing switching characteristics of example (enhancement mode) power transistors during controlled DC bus discharge, in accordance with embodiments of the present disclosure; view (a) shows diagram 402 of switching characteristics of the power transistor during controlled DC bus discharge; view (b) shows diagram 404 including a highlighted portion of a particular area of interest of diagram 402 with respect to controlled discharge; view (c) shows diagram 406 depicting application of pre-programmed power transistor gate pulses at a limited voltage level just above gate threshold voltage (Vgs_th); and, view (d) depicts diagram 408 showing operation and monitoring of a power transistor for active DC bus discharging, in accordance with embodiments of the present disclosure.

View (a) of FIG. 4 depicts diagram 402 showing applied gate-source voltage, Vgs, for the example power transistor. The threshold gate voltage, Vgs_th, and Miller plateau voltage, Vm, are indicated. Current from the drain, Id, and voltage across the drain and source, Vds, are also shown. View (a) shows the relationship between gate-source voltage, Vgs, and drain current, Id. Once the gate threshold voltage, Vgs_th, is exceeded, drain current is initiated and it increases linearly with the increase in gate-source voltage, Vgs, until the Miller plateau (region) is reached. Once the Miller plateau is reached, the drain current (Id) becomes level (plateaus) or substantially level, or has a relatively low-value positive slope, while the drain-source voltage (Vds) decreases linearly.

View (b) of FIG. 4 depicts diagram 404 showing a highlighted portion of a particular area of interest of diagram 402 with respect to controlled discharge. As shown, once Vgs exceeds Vgs_th, (i) drain current (Id) begins, and (ii) drain-source voltage (Vds) starts to decrease.

View (c) of FIG. 4 depicts diagram 406 showing operation a power transistor as controlled by a gate driver (e.g., gate driver 312A shown in FIG. 3) issuing or providing pre-programmed voltage pulses (gate pulses) limited to a level just above Vgs_th, in accordance with example embodiments of the present disclosure. Representative maximum voltage level 407 is shown at a value below the Miller plateau voltage (Vm). While one particular value of 407 is shown, any other value may be used below the value of the Miller plateau voltage (Vm).

Application of such voltage pulses forces limited current (pulses) through the power transistor for discharge of a capacitor bank of a connected DC bus (e.g., capacitor bank 303 shown FIG. 3). Frequency and duty cycle of such pre-programmed pulse can be selected (designed for) to produce a desired/optimal capacitor bank discharge schedule, e.g., to meet specified safety requirements.

View (d) of FIG. 4 depicts diagram 408 showing operation and monitoring of a power transistor for active DC bus discharging, in accordance with embodiments of the present disclosure. The power transistor can be controlled by a gate driver (e.g., gate driver 312C shown in FIG. 3) to produce a constant current charge. A transition to the Miller plateau can be detected by sensing the rate of change of gate voltage under constant current charge. A change in slope of the gate voltage, from one positive slope value to another slope value (e.g., a lesser positive slope), can be used (inferred) as an indication of the transition of the transistor from the desired linear region to the Miller plateau. Once detected, the charge event could be terminated by the gate driver and a discharge event could be initiated by the gate driver, as shown. Operation of the power transistor can thus be maintained in the linear region, drawing charge, e.g., from the capacitor bank of a connected DC bus. Such operation of the gate driver and power transistor can be implemented for multiple bridges of a traction inverter and DC bus used for an EV or hybrid vehicle having an AC motor. The discharge of the capacitor bank used for the DC bus can accordingly be safely managed/controlled by repeating the operation with appropriate frequency and duty cycle.

While FIG. 4 depicts operation of example enhancement mode transistors, the principle as illustrated in FIG. 4 is still applicable to depletion mode transistors except that gate voltage threshold Vgs_th would be negative and the starting point for the gate voltage would be from a negative level below Vgs_th.

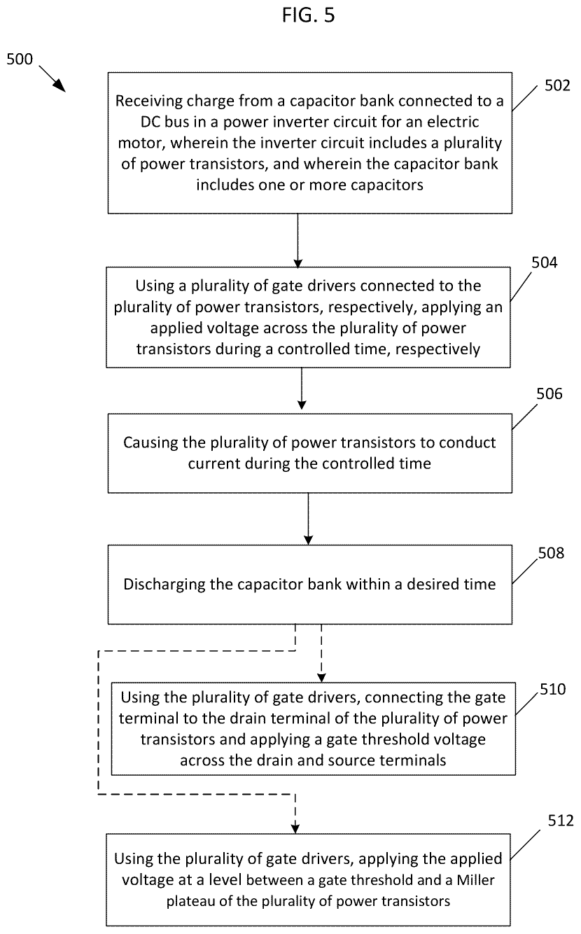

FIG. 5 is diagram for an example method 500 of controlled DC bus discharge, in accordance with an embodiment of the present disclosure. Method 500 can include receiving charge from a capacitor bank connected to a DC bus in a traction inverter (power inverter) circuit used for an electric motor (e.g., a permanent magnet synchronous motor, or “PMSM”), with the inverter circuit including a plurality of power transistors, as shown at 502. The capacitor bank can include one or more capacitors, e.g., of a suitable size for a given application. A plurality of gate drivers can be connected to the plurality of power transistors, respectively, for applying an applied voltage across the plurality of power transistors during a controlled time, respectively, as shown at 504.

Method 500 can include causing the plurality of power transistors to conduct current during the controlled time, as shown at 506. The capacitor bank can be discharged within a desired time, as shown at 508. Using the plurality of gate drivers, the gate terminal can be connected to the drain terminal of the plurality of power transistors and a gate threshold voltage can be applied across the drain and source terminals, as shown at 510. Using the plurality of gate drivers, the applied voltage can be applied at a level between a gate threshold and a Miller plateau of the plurality of power transistors, as shown at 512.

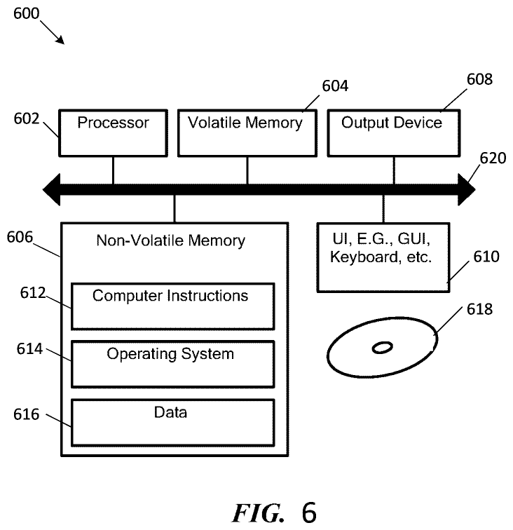

FIG. 6 is a is a schematic diagram of an example computer system 600 that can perform all or at least a portion of the processing, e.g., steps in the algorithms and methods, including control of traction inverter switching and/or slope-change detection, as described herein. The computer system 600 includes a processor 602, a volatile memory 604, a non-volatile memory 606 (e.g., a hard disk), an output device 608 and a user input or interface (UI) 610, e.g., graphical user interface (GUI), a mouse, a keyboard, a display, and/or any common user interface, etc. The non-volatile memory (non-transitory storage medium) 606 stores computer instructions 612 (a.k.a., machine-readable instructions or computer-readable instructions) such as software (computer program product), an operating system 614 and data 616. In one example, the computer instructions 612 are executed by the processor 602 out of (from) volatile memory 604. In one embodiment, an article 618 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 600 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry, e.g., an FPGA (field programmable gate array) and/or an ASIC (application-specific integrated circuit).

Accordingly, embodiments of the inventive subject matter can afford various benefits relative to prior art techniques. For example, embodiments and examples of the present disclosure can provide for or facilitate controlled discharge of a capacitor bank used for a DC bus or EV inverter (or other application).

Various embodiments of the concepts, systems, devices, structures, and techniques sought to be protected are described above with reference to the related drawings. Alternative embodiments can be devised without departing from the scope of the concepts, systems, devices, structures, and techniques described. For example, while reference is made to enhancement mode power transistors for some embodiments and examples, other embodiments and/or examples can include use of depletion mode power transistors within the scope of the present disclosure.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more” and “at least one” indicate, unless expressly stated otherwise herein, any integer number greater than or equal to one, e.g., one, two, three, four, etc.; in some embodiments, where context admits, the terms “one or more” and “at least one” can indicate a fractional value. The term “plurality” indicates any integer number greater than one. The term “connection” can include an indirect “connection” and a direct “connection.”

References in the specification to “embodiments,” “one embodiment,” “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the description provided herein or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A system for discharging a capacitor bank of a DC bus in a power inverter circuit for an electric motor, the system comprising:
circuitry configured to receive charge from the capacitor bank connected to the DC bus, wherein the capacitor bank includes one or more capacitors;
a plurality of power transistors connected to the DC bus and configured to provide power to the electric motor, wherein each power transistor has drain, gate, and source terminals; and
a plurality of gate drivers connected to the plurality of power transistors, respectively, wherein the plurality of gate drivers is configured to apply an applied voltage across the plurality of power transistors during a controlled time, respectively, and to cause the plurality of power transistors to conduct current during the controlled time, wherein charge is controllably dissipated from the capacitor bank during the controlled time.

2. The system of claim 1, wherein the plurality of gate drivers is configured to connect the gate terminal to the drain terminal of the plurality of power transistors, respectively, and to apply the applied voltage across the drain and source terminals, respectively.

3. The system of claim 2, wherein the applied voltage comprises a gate threshold voltage of the plurality of power transistors.

4. The system of claim 2, wherein the applied voltage is between a gate threshold voltage and a voltage corresponding to a Miller plateau of a gate-charge curve of the plurality of power transistors.

5. The system of claim 4, wherein the plurality of gate drivers is configured to a monitor slope change of the gate-charge curve to detect a transition to the Miller plateau.

6. The system of claim 5, wherein the plurality of gate drivers is further configured to respond to the transition to the Miller plateau by terminating a charge event of the plurality or power transistors and initiating a discharge event.

7. The system of claim 1, wherein the plurality of gate drivers is configured to cause the plurality of power transistors to operate in a linear region of a gain curve of the plurality of power transistors during the controlled time.

8. The system of claim 1, wherein the plurality of gate drivers comprises a plurality of programmable gate drivers.

9. The system of claim 8, wherein the plurality of programmable gate drivers is configured to apply the applied voltage according to a duty cycle.

10. The system of claim 1, wherein the plurality of power transistors comprises enhancement mode transistors.

11. The system of claim 1, wherein the plurality of power transistors comprises depletion mode transistors.

12. The system of claim 1, wherein the plurality of power transistors comprises MOSFETs.

13. The system of claim 1, wherein the plurality of power transistors comprises MESFETs.

14. The system of claim 1, wherein the plurality of power transistors comprises JFETs.

15. The system of claim 1, wherein the plurality of power transistors comprises silicon carbide (SiC) FETs.

16. The system of claim 1, wherein the plurality of power transistors comprises gallium nitride (GaN) FETs.

17. The system of claim 1, further comprising a battery configured to provide power to the electric motor.

18. The system of claim 17, wherein the battery is configured to store power received from the electric motor.

19. The system of claim 1, wherein the electric motor comprises a permanent magnet synchronous motor (PMSM).

20. The system of claim 1, wherein the plurality of gate drivers is configured to adjust the applied voltage based on a temperature associated with the plurality of power transistors.

21. A method of discharging a capacitor bank coupled to a DC bus in a power inverter circuit for an electric motor, wherein the power inverter circuit includes a plurality of power transistors configured to provide power to the electric motor, each having drain, gate, and source terminals, the method comprising:
receiving charge from the capacitor bank connected to the DC bus, wherein the capacitor bank includes one or more capacitors;
using a plurality of gate drivers connected to the plurality of power transistors, respectively, applying an applied voltage across the plurality of power transistors during a controlled time, respectively;
causing the plurality of power transistors to conduct current during the controlled time; and
discharging the capacitor bank within a desired time.

22. The method of claim 21, wherein the plurality of gate drivers is configured to connect the gate terminal to the drain terminal of the plurality of power transistors, respectively, and to apply the applied voltage across the drain and source terminals, respectively.

23. The method of claim 22, wherein the applied voltage comprises a gate threshold voltage of the plurality of power transistors.

24. The method of claim 22, wherein the applied voltage is between a gate threshold voltage and a voltage corresponding to a Miller plateau of a gate-charge curve of the plurality of power transistors.

25. The method of claim 24, further comprising monitoring a slope change of the gate-charge curve to detect a transition to the Miller plateau.

26. The method of claim 25, further comprising responding to the transition to the Miller plateau by terminating a charge event of the plurality or power transistors and initiating a discharge event.

27. The method of claim 21, wherein the plurality of gate drivers is configured to cause the plurality of power transistors to operate in a linear region of a gain curve of the plurality of power transistors during the controlled time.

28. The method of claim 21, wherein the plurality of gate drivers comprises a plurality of programmable gate drivers.

29. The method of claim 28, wherein the plurality of programmable gate drivers is configured to apply the applied voltage according to a duty cycle.

30. The method of claim 21, wherein the plurality of gate drivers is configured to apply the applied voltage according to a duty cycle.

31. The method of claim 21, wherein the plurality of power transistors comprises enhancement mode transistors.

32. The method of claim 21, wherein the plurality of power transistors comprises depletion mode transistors.

33. The method of claim 21, wherein the plurality of power transistors comprises MOSFETs.

34. The method of claim 21, wherein the plurality of power transistors comprises MESFETs.

35. The method of claim 21, wherein the plurality of power transistors comprises JFETs.

36. The method of claim 21, wherein the plurality of power transistors comprises silicon carbide (SiC) FETs.

37. The method of claim 21, wherein the plurality of power transistors comprises gallium nitride (GaN) FETs.

38. The method of claim 21, wherein the electric motor comprises a permanent magnet synchronous motor (PMSM).

39. The method of claim 21, further comprising adjusting the applied voltage based on a temperature associated with the plurality of power transistors.
